(19) United States
(12) Patent Application Publication
(10) Pub. No.: US 2022/0331818 A1
(43) Pub. Date: Oct. 20, 2022

(54) Disposable Centrifuge Pot

(71) Applicant: PROLIGHT DIAGNOSTICS AB, Lund (SE)

(72) Inventor: Andrew Malloy, Royston Hertfordshire (GB)

(73) Assignee: PROLIGHT DIAGNOSTICS AB, Lund (SE)

(21) Appl. No.: 17/760,616

(22) PCT Filed: Sep. 16, 2020
(86) PCT No.: PCT/GB2020/052234

§ 371 Date: Mar. 15, 2022

(30) Foreign Application Priority Data
Sep. 16, 2019 (GB) 1913321.4

(51) Int. Cl. B04B 7/12; B04B 5/04; B04B 1/06

(52) U.S. Cl. CPC B04B 7/12; B04B 5/0407; B04B 1/06

(57) ABSTRACT

A pot for centrifugal separation of a biological fluid into multiple components. The pot comprises a wall (111) around a central axis (112), a top end (121) and a bottom end (113). The pot also comprises a plurality of baffles (114) protruding from the wall (111) into an inner volume of the pot, and/or a protrusion from the bottom end into the inner volume and around the central axis. Also, a consumable cartridge comprising the pot, a cartridge body adapted to receive the pot, and a first holding means. The first holding means is for holding the pot at least partly within the cartridge body, and is adapted to allow the pot to rotate.

### TECHNICAL FIELD

The present disclosure relates to pots for use in centrifugal separation of biological liquids into different phases (for example in diagnostics, therapeutics, sample preparation). The disclosure also relates to consumable cartridges suitable for use with centrifuge instruments and point-of-care diagnostic instruments.

### BACKGROUND

Many biological liquids (for example blood, urine) are complex mixtures of many different components. There is often a need to be able to separate these components to perform analysis on the liquid (for example in a diagnostic test) to void some parts of the liquid interfering with the analysis.

For example, a common requirement is to be able to separate a whole blood sample into its liquid plasma component separated from the cellular matter of the blood (red and white blood cells). The vast majority of analytical blood tests actually require the liquid plasma to be used as the input sample material as the cellular matter can interfere with many analytical tests. This is normally accomplished using centrifugation. The sample is spun at high speed in a bench-top laboratory centrifuge which separates the blood into components according to their relative densities with the lighter liquid plasma remaining on top of the tube after spinning and available to be aspirated off.

In order to generate the centrifugal force necessary to achieve separation of the blood, the sample is spun some distance away from an axis at high speed. This is often achieved by using sample tubes placed 5-20 cm away from the rotational axis and at an angle of 20-45 deg from the vertical. The angled tubes help to maintain the plasma and blood separation as the centrifuge comes to a stop.

As the sample is placed at an angle in a traditional centrifuge, the process of loading and unloading the sample requires some level of complexity to avoid spilling or remixing the sample. Therefore, such centrifuges either require significant manual intervention to load and unload the sample and extract the generated plasma, or a large and complex machine is required to automate this process limiting it to, for example central lab instruments.

However, there is an increasing need to be able to generate plasma samples outside of a laboratory. For example, many diagnostic tests developed for use at the point of care would benefit from being able to take a whole blood input and to be able to separate the plasma within a point-of-care test system to actually perform the analytical chemistry with the plasma.

There are a few examples in the prior art that attempt to meet this challenge:

The first is the use of a separation filter instead of centrifugation to separate the blood from plasma. For example, the Pall Vivid Membrane. This works by size filtration, trapping the cells that are too large to pass through the filter. However, this approach is slow, relying on capillary action to wick the sample through the membrane, inefficient with only a maximum of typically 80% of available plasma extracted, prone to contamination as the filter can cause cells to lyse releasing harmful cell contents into the plasma, and filters can typically only process up to ˜100 uL of blood sample input before they get clogged with cells.

A second example is the use of a micro-fluidic centrifugal disc where the entire fluidic system is built on a rotating platform that includes specific elements to separate a blood sample into plasma in the same device. However, this restricts its use to those workflows that can be built into a rotating fluidic disc and the maximum volumes are again limited to those that can easily be accommodated on micro-fluidic discs, typically of the order of 100 uL.

The current art is missing a device that is suitable for separating larger volumes (>500 ul) of blood into plasma in a way that could be integrated into a simple fluidic cartridge for use at the point of care.

### SUMMARY OF THE DISCLOSURE

The present disclosure provides a solution to the above problem using a pot which is adapted to allow centrifugation to take place by spinning the pot about its own axis, thus negating the need for any complex movements or rotations during the process. The simplicity afforded by this design allows for the integration of this pot into a disposable cartridge suitable for use in point of care workflows.

According to a first aspect, the present disclosure provides a pot for centrifugal separation of a biological fluid into multiple components, the pot comprising a wall around a central axis, a top end and a bottom end. The pot comprises: a plurality of baffles protruding from the wall into an inner volume of the pot; and/or a protrusion from the bottom end into the inner volume and around the central axis.

Optionally, the pot is adapted to be spun on the central axis for centrifugal separation of the biological fluid in the inner volume, wherein the multiple components remain separated once the pot ceases to spin.

Optionally, each of the plurality of baffles does not protrude as far as a centre of the pot, and extends along the wall for between half of and all of a distance between the top end and the bottom end.

Optionally, the plurality of baffles are substantially equally spaced around the central axis.

Optionally, the plurality of baffles comprises a first baffle that protrudes from the wall by a first distance and a second baffle that protrudes from the wall by a second distance, the first distance being different from the second distance.

Optionally, the plurality of baffles are each formed as an arc of a curve in a plane defined by the central axis, the curve having a radius between 0.12 and 0.18 of a width of the pot.

Optionally, the protrusion from the bottom end is formed around the central axis with a width of approximately half of a width of the pot, and protrudes between 1 mm and 4 mm from the bottom end.

Optionally, the centrifugal separation separates plasma towards the central axis, and the pot is adapted to enable a component of the biological fluid to be extracted through an opening in the top end.

Optionally, a width of the pot is less than 40 mm.

Optionally, a distance between the top end and the bottom end is less than 30 mm.

Optionally, the pot is adapted to be spun at at least 10,000 RPM.

Optionally, the biological fluid is blood and the multiple components of the biological fluid comprise plasma and cellular matter.

According to a second aspect, the present disclosure provides a consumable cartridge comprising: a pot according to the first aspect, a cartridge body adapted to receive the pot, and a first holding means for holding the pot at least partly within the cartridge body, wherein the first holding means is adapted to allow the pot to rotate.

Optionally, the consumable cartridge further comprises a second holding means adapted to securely hold the pot in place until the cartridge is inserted into a centrifuge instrument, and to release the pot to spin freely when the cartridge is inserted into the centrifuge instrument.

Optionally, the consumable cartridge further comprises a dispensing element adapted to dispense a biological fluid into the pot, and an aspirating element adapted to extract a component of the biological fluid from the pot, wherein the cartridge does not comprise any moving parts other than the pot.

Optionally, the cartridge is adapted to hold the pot at least partly within the cartridge body when the pot is spinning at at least 10,000 RPM.

### BRIEF DESCRIPTION OF THE DRAWINGS

FIG. 1 is a schematic exploded view of a pot for centrifugal separation of plasma from blood;

FIG. 2 is a schematic plan view of the pot of FIG. 1;

FIGS. 3A to 3E schematically illustrate centrifugal separation of plasma from blood in the pot of FIG. 1;

FIGS. 4A and 4B schematically illustrate a consumable cartridge having the pot of FIG. 1 in a consumable cartridge;

FIGS. 5A and 5B schematically illustrate use of the consumable cartridge of FIGS. 4A and 4B with a centrifuge instrument;

FIG. 6 schematically illustrates a centrifuge instrument for use with a consumable cartridge;

FIG. 7 is a schematic plan view of baffles in an alternative pot;

FIG. 8 is a schematic plan view of baffles in a further alternative pot;

FIG. 9 is a schematic plan view of baffles in a further alternative pot;

FIG. 10 is a schematic plan view of baffles in a further alternative pot;

FIG. 11 is a schematic plan view of baffles in a further alternative pot.

### DETAILED DESCRIPTION

The present disclosure provides a rotatable pot that, when spun along its axis, can effect the separation of the cellular matter from blood via centrifugation. By virtue of the design disclosed here, the cellular matter of the blood remains separated from the liquid portion (plasma) even when the pot comes to a complete stop, or at least decreases a speed of remixing between the separated blood and plasma, thereby extending the time in which it is possible to extract the plasma for analysis. In addition, the design enables the pot to be integrated within a disposable cartridge to allow the inclusion of a centrifugation step within an existing micro- or meso-fluidic workflow.

The design of the pot reduces the complexity normally associated with integrating a centrifugation step within a workflow that could be useful, for instance, at the point of care, and can be performed using smaller, lower cost equipment than would conventionally be available in a large-scale central lab.

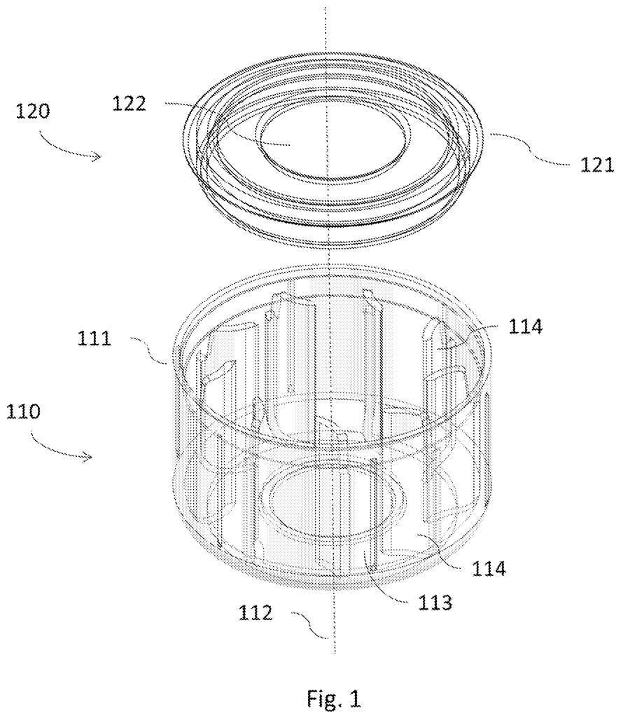

FIG. 1 illustrates a pot comprising a lower part 110 and an upper part 120.

The lower part 110 comprises a wall 111 around a central axis 112, and a bottom end 113, which together define an inner volume that can contain a liquid such as blood.

In this example, the wall has a round, cylindrical shape. However, in other examples, the wall may instead be polygonal, so long as a central axis can be defined.

The upper part 120 comprises a top end 121 of the pot. In this example, the upper part 120 further comprises an opening 122 that is a permanently open hole through which contents of the pot may be added or removed. Even in examples where the upper part 120 comprises an opening, the upper part 120 prevents liquid from spilling out of the pot when it is spun.

Centrifugation of blood separates plasma towards the central axis 112 and therefore including the opening 122 at or near to the middle of the top end 121 enables extraction of separated plasma through the opening 122.

In this example, the upper part 120 is manufactured separately from the lower part 110, and acts as a removable lid for the lower part 110. The design of this pot disclosed in this invention can be made using for example, two injection moulded parts. However, the lower part 110 and upper part 120 may instead be formed together as a unitary pot. The upper and lower parts of the pot may be welded together or, in another example, blow-moulding may be used to create the pot as a single part.

In this example, the lower part 110 additionally comprises a plurality of baffles 114 protruding from the wall into the inner volume. The baffles may take a variety of shapes, as explained below, but in this example the baffles are scalloped. The scalloped shape of the baffles has the effect of preventing re-mixing of separated blood and plasma when the pot experiences a decelerating force at the end of centrifugation. Alternatively, the baffles may be omitted.

In an example having a volume useful for point-of-care applications, the pot has a radius of less than 20 mm and a height (i.e. a distance between the top end 121 and the bottom end 113) of less than 30 mm. The pot may be cylindrical, in which case “radius” takes its normal meaning. However, this is merely the simplest case and the pot may have a less smooth, polygonal, cross-section. In such alternatives, “radius” refers to half of the average width across the polygonal cross-section, and is alternatively called the “half-width” herein. Therefore, the pot may, more generally, usefully have a width of less than 40 mm.

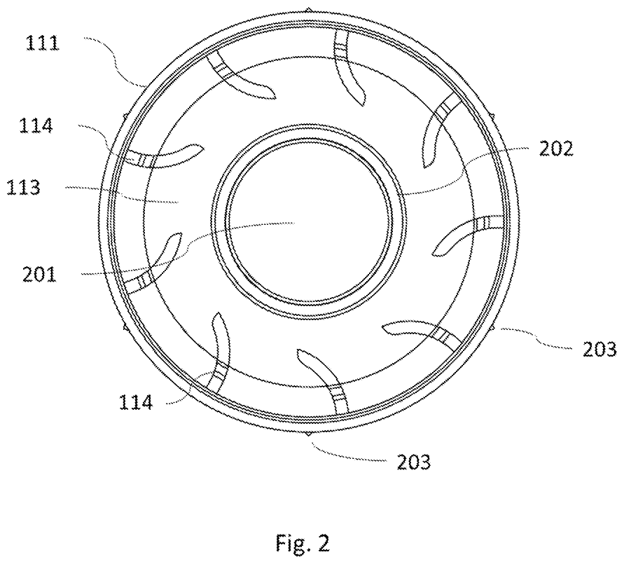

FIG. 2 provides a plan view of the pot in which the baffles can be more easily seen.

In this example, each of the plurality of baffles 114 does not protrude as far as a centre 201 of the pot (corresponding to the central axis 112) and extends along the wall (i.e. out of the plane of FIG. 2) for between half of and all of the height of the wall (i.e. the distance between the top end 121 and the bottom end 113).

Additionally, in this example, the plurality of baffles 114 are substantially equally spaced around the centre 201 (corresponding to the central axis 112).

Additionally, as shown in FIG. 2, in this example, the lower part 110 comprises a protrusion 202 from the bottom end 113. The protrusion 202 extends into the inner volume and around the centre 201 (corresponding to the central axis 112). Such a protrusion 202 may be formed around the central axis 112 with a radius of approximately half of the radius of the pot. In other words, in the case of a cylindrical pot as shown in FIG. 2, the protrusion 202 may take the shape of a circle of about half the radius of the pot. As with the wall 111, the protrusion 202 need not be a smooth shape, and may instead be polygonal.

The protrusion 202 provides a small inner wall extending from the bottom of the pot. When blood is centrifuged in the pot, this inner wall feature helps to trap separated cellular matter away from the centre 201 of the pot, helping to maintain separation of plasma in the centre of the pot for longer after centrifugation. This effect is particularly enhanced in cases where the protrusion 202 protrudes between 1 mm and 4 mm from the bottom end.

Since both of the baffles 114 and the protrusion 202 independently assist in isolating plasma for longer, either the baffles 114 or the protrusion 202, or more preferably both, may be included in examples of the invention.

Additionally, as shown in FIG. 2, the pot of this example includes one or more outer ribs 203 on an external surface of the wall 111. These outer ribs 203 can be provided to engage with a rotor of a centrifuge instrument in order to prevent slipping when the rotor is driving rotation of the pot.

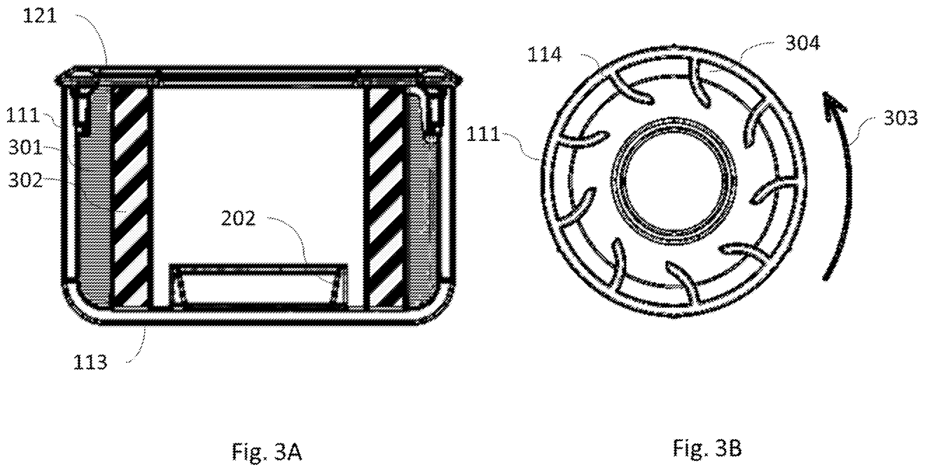

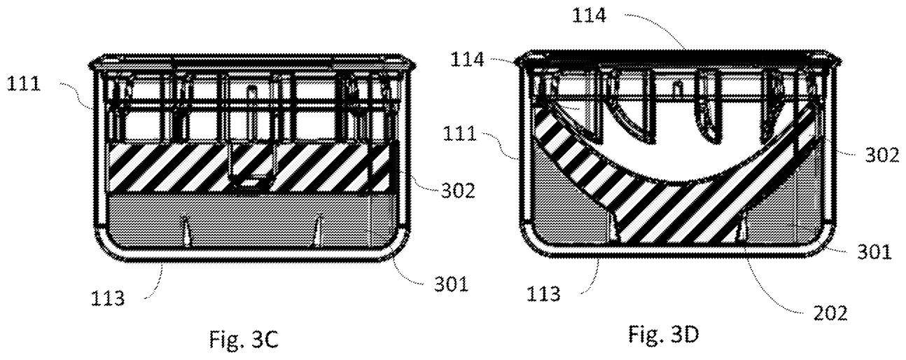

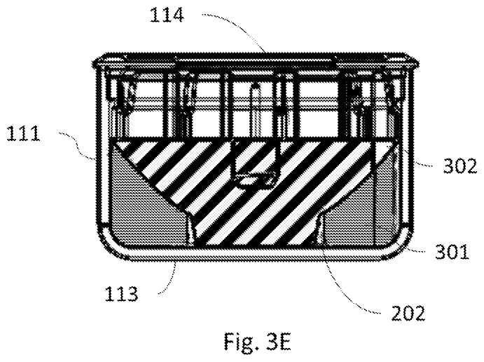

Referring now to FIGS. 3A to 3E, the principles of centrifugation of blood in the pot will be explained.

When the pot is spun around the central axis 112, the liquid contained therein is centrifuged, which may be used to separate plasma from blood. More specifically, by virtue of the centrifugal forces imparted on the blood by spinning, denser cellular matter 301 of the blood migrates away from the central axis 112 and less dense plasma material 302 migrates towards the central axis 112. This is illustrated in FIG. 3A which represents a pot spinning 4 ml of blood at 12,000 revolutions per minute (RPM) to give 2 ml of cellular matter 301 and 2 ml of plasma 302.

The centrifugal force that the blood is subjected to is a function of the both the radius (rₚₒₜ—expressed here in millimetres) and angular velocity or rotation speed (ω—expressed here in revolutions per minute) of the pot and is often expressed in terms of a relative centrifugal force F_{RCF} which expresses the force relative to that experienced by a 1 kg mass falling under Earth's gravity:

F_{RCF}=1.12 ω²rₚₒₜ

This means that as the pot radius (or more generally half-width) decreases, a larger rotation speed is required to separate the plasma from the blood. For the devices envisioned by this invention, the pot radius can be as small as, for example, 10 mm-20 mm which then requires the pot to rotate with an angular velocity of between 10,000 RPM and 20,000 RPM to achieve a relative centrifugal force of between 500 g-2,000 g which is typically understood to be required to enable separation of blood from plasma.

Accordingly, the pot may be adapted to tolerate being spun at at least 10,000 RPM.

In particular, at these high rotational speeds, it is critical that the pot has a symmetric mass balance about its central axis 112 to ensure that there are no significant off-axis mechanical forces generated by the rotation that could damage a centrifuge mechanism with which the pot is used. Automatic mass-balancing may be achieved to a large extent by adapting the pot to be spun on its own central axis 112. As the mass of the blood that is being spun can be of a similar or even greater level than the mass of the pot, the liquid blood will naturally act to compensate for any off-axis or non-symmetric mass distributions in the pot itself. This enables the pot to be made via methods that do not require accurate or precise mass distributions. For example, simple plastic injection moulding would be suitable for manufacturing the pot because any resulting irregularities or non-symmetric mass distributions would be compensated for by the mass of the blood spinning within the pot.

A pot which tolerates high rotational speeds requires that the materials used to construct the pot are of sufficient strength to withstand the centrifugal stresses generated. An example of such a suitable material could be polypropylene or polycarbonate.

FIG. 3B is a schematic plan view of the pot during rotation corresponding to FIG. 3A. Arrow 303 illustrates a direction of rotation. In examples with scalloped baffles 114, the direction of rotation is chosen such that the baffles 114 curve against the direction of motion. This means that, when the pot slows its rotation, the inertia of the contents of the pot directs the contents into the regions 304 between the baffles 114 and the wall 111.

When a conventional pot decelerates, the effective force acting on the blood changes from horizontal (centrifugal) to vertical (gravity). In theory, this change of effective forces would allow the plasma to be aspirated as, under gravity, the plasma 302 comes to rest on top of the denser blood cellular material 301. This conventionally-theoretical result is represented in FIG. 3C.

However, in practice it is very difficult to achieve a smooth enough deceleration to prevent re-mixing of the blood and plasma as the pot comes to a stop, and therefore the distribution shown in FIG. 3C is not normally achieved in practice. Further, even if the distribution shown in FIG. 3C can be achieved, it is difficult to only aspirate the plasma 302 from atop the cellular material 301 without careful alignment of an aspiration needle.

The pot described herein is adapted to overcome this limitation, and make aspiration of the plasma 302 without aspirating the cellular material 301 easier and more effective.

More specifically, the inclusion of the baffles 114 as shown in FIG. 3B cause the denser cellular material 301, which has greater inertia than the plasma 302, to collect in the regions 304 between the baffles 114 and the wall 111. This prevents the cellular material 301 from moving radially inward as the pot reduces its rotation speed, and prevents the re-mixing of the separated cellular material 301 and plasma 302 upon deceleration. Effectively, the baffles 114 turn the pot into a series of isolated chambers 304, which helps reduce the ability of shear forces of the wall 111 against the cellular material 301 to cause re-mixing.

Simultaneously, the protrusion 202 prevents cellular material 301, which has collected under gravity at the bottom of the pot, from moving towards the centre 201.

These combined effects lead to the sequence shown in FIG. 3D, 3E and, finally, achieve the distribution of FIG. 3C in practice. More specifically, FIG. 3D is a schematic illustration of an example pot when it is slowing down after centrifugation, when it is still rotating at 300 RPM, FIG. 3E is a schematic illustration of the pot just after it has stopped rotating, and the distribution of FIG. 3C is reached by one minute after the pot has stopped rotating.

More specifically, in FIG. 3D, it can be seen that the combination of the baffles 114 and the protrusion 202 has caused the cellular material 301 to settle between the protrusion 202 and the wall 111. On the other hand, the continuing rotation at this stage means that the surface of the separated plasma 302 curves upwards away from the central axis 112.

Then, in FIG. 3E, when the rotation has stopped the plasma 302 settles to have a flat horizontal surface. On the other hand, surface tension at the meeting point between the plasma 302, the cellular material 301 and the protrusion 202 prevents the cellular material 301 from spilling over the protrusion 202. Thus, the cellular material 301 remains sloped outside the protrusion 202 and the central area inside the protrusion 202 contains only plasma 302.

Even with the features of the invention, this situation is only temporary and thus, by one minute after the pot stops rotation, the distribution shown in FIG. 3C appears due to gravitational effects on the separated plasma 302 and cellular material 301.

Due to the protrusion 202 and the baffles 114, this settling is delayed substantially until after the pot has stopped rotating, and thus far less re-mixing occurs during the settling making the distribution of FIG. 3C, wherein the plasma 302 remains separated from the cellular material 301 once the pot ceases to spin, practically achievable.

Additionally, by providing alternative features to achieve the distribution of FIG. 3E, even temporarily, the pot of the invention provides an opportunity to aspirate the plasma from the centre 201 of the pot without requiring careful alignment of an aspiration means (such as an aspiration needle).

Unlike traditional centrifuges and centrifuge pots, where the containers are spun at an angle with respect to gravity, the above described system enables the pot to be spun on its axis parallel with gravity. This allows for the use of a very simple instrument to carry out the centrifugation and consequently reduces the complexity of the fluidics necessary to collect the generated plasma from the device. The pot does not require rotation about any other axis in order to extract the generated plasma from the top of the pot.

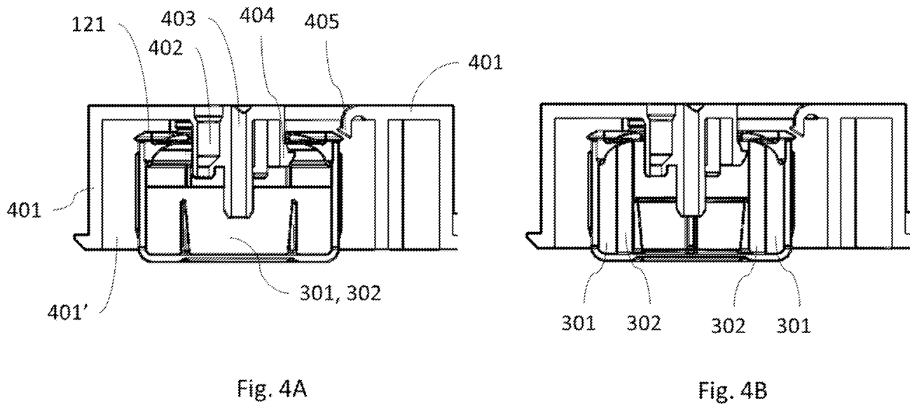

This reduced complexity enables the pot to be used within a simple disposable cartridge as shown, for example, in FIGS. 4A and 4B.

FIGS. 4A and 4B schematically illustrate a consumable cartridge having a pot as previously described. FIG. 4A shows the cartridge in an initial fill state where the pot has been filled with 4.5 ml of blood 301, 302. FIG. 4B shows the cartridge during centrifugation, wherein the pot is rotating in the cartridge at 12,000 RPM and the blood has separated into cellular material 301 and plasma 302.

In particular, FIGS. 4A and 4B show a cross-section through the cartridge and through the pot. The cartridge has a cartridge body 401 which is cut through in an intended vertical plane of the pot. It can be seen in FIGS. 4A and 4B that the cartridge body 401 extends on either side of the pot and the cartridge body 401′ also extends around behind the pot, such that the cartridge body 401, 401′ is adapted to receive the pot at least partly within the cartridge body. However, the pot may also extend beyond the cartridge body 401, 401′ as shown at the bottom of FIGS. 4A and 4B.

Additionally, the cartridge comprises a dispensing element 402 for dispensing blood 301, 302 into the pot, and an aspirating element 403 for extracting plasma 302 from the pot. The dispensing element 402 and aspirating element 403 may approximately take the form of a needle. The dispensing element 402 and aspirating element 403 may be attached to the cartridge body 401 or may be formed as part of the cartridge body 401. In this example, the dispensing element 402 and the aspirating element 403 extend through the opening 122 in the top end 121, and remain in the pot during centrifugation as shown in FIG. 4B. More specifically, the aspirating element 403 is located on the central axis 112 of the pot such that it is appropriately positioned to quickly take advantage of the temporary distribution of plasma 302 shown in FIG. 3E, as explained above. Thus no moving parts are required for the dispensing element 402 and the aspirating element 403. Accordingly, it is not necessary to introduce a moving aspirating element after centrifugation, which would conventionally disrupt the separated components and cause some re-mixing. More generally, a cartridge as described herein does not require any moving parts other than the pot, which simplifies construction of the cartridge. In alternative examples, the dispensing element 402 and aspirating element 403 may be omitted or replaced with moving parts, and the cartridge may only provide a convenient means for holding the pot during rotation.

As further shown in FIGS. 4A and 4B, the cartridge also comprises a first holding means 404 for holding the pot at least partly within the cartridge body, while allowing the pot to rotate. More specifically, in this example, the first holding means extends with the dispensing element 402 and aspirating element 403 into the pot through the opening 122. The first holding means has a protrusion which extends radially beyond the opening 122 such that the first holding means cannot pass through the opening 122. This means that the pot must remain at least partly within the cartridge body. However, this does not prevent the pot from rotating around the dispensing element 402, aspirating element 403 and first holding means 404. In particular, there is sufficient clearance between the protrusion of the first holding means 404 and the cartridge body 401 to allow rotation of the pot without friction against the cartridge body 401 or the clip 404.

The first holding means 404 may be provided in the form of a flexible clip comprising a flange that is sloped on one side. This allows for snap fit assembly of the cartridge by sliding the pot over the dispensing element 402, aspirating element 403 and first holding means 404. In such cases, the flexible clip must be stiff enough to prevent a reversal of the snap-fit connection due to forces experienced during centrifugation of the pot. The first holding means 404 may be attached to the cartridge body 401 or may be formed as part of the cartridge body 401.

Optionally, the cartridge may also comprise a second holding means 405 adapted to securely hold the pot in place until the cartridge is inserted into a centrifuge instrument for driving rotation of the pot, and adapted to release the pot to spin freely when the cartridge is inserted into the centrifuge instrument.

The second holding means 405 may be a flexible clip similar to the first holding means. However, the secure hold of the second holding means 405 may be provided by locating the second holding means close to a surface of the cartridge body 401, such that the pot can be secured between the second holding means 405 and the cartridge body 401. In such a position, friction between the pot, the cartridge body 401 and the second holding means 405 may be sufficient to prevent rotation of the pot. Additionally, the second holding means 405 may provide a reversible connection, so that the pot can disengage from the second holding means 405 to be released to spin freely during centrifugation. The second holding means 405 may be attached to the cartridge body 401 or may be formed as part of the cartridge body 401.

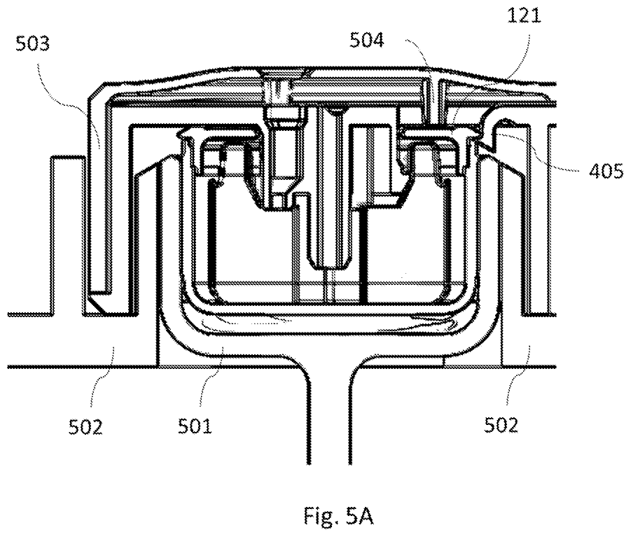

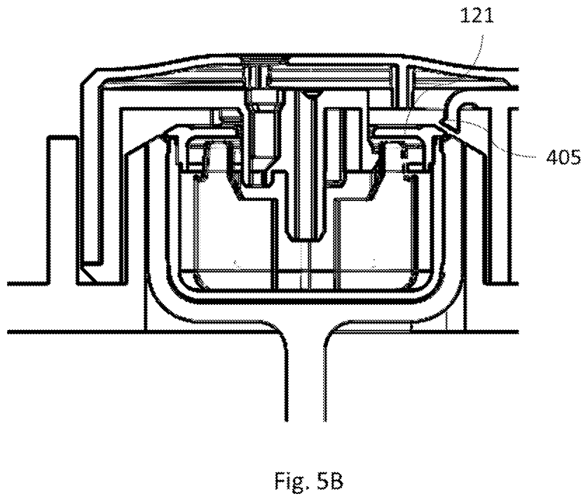

FIGS. 5A and 5B illustrate what happens when the cartridge is inserted into a centrifuge instrument. In particular, FIGS. 5A and 5B illustrate the cartridge before and after the pot has been disengaged from the second holding means 405.

As shown in FIG. 5A, the centrifuge instrument may comprise a rotor 501 and first and second cartridge holding means 502 and 503 for securing the cartridge during centrifugation. The centrifuge instrument and cartridge may also comprise corresponding interfaces for allowing the centrifuge instrument to connect to the dispensing element 402 and aspirating element 403 of the cartridge. Furthermore, the centrifuge instrument may be part of an integrated diagnostic instrument for both centrifuging blood and analysing the obtained plasma.

The rotor 501 may engage with the outer ribs 203 of the pot (if present) or may use friction with an outer surface of the pot to drive rotation of the pot during centrifugation.

Additionally, the centrifuge instrument may comprise a disengaging means 504 to provide the force to disengage the second holding means 405 from the pot (if the second holding means is present). Such a disengaging force may be transmitted through the top end 121 of the pot, as shown in FIGS. 5A and 5B.

This disengaging means 504 could be a passive extension which disengages the second holding means 405 from the pot when the first and second cartridge holding means 502 and 503 are secured around the cartridge. Alternatively, the disengaging means 504 could be an active linear actuator, controlled to disengage the pot from the second holding means 405 only when the centrifuge instrument is ready to perform centrifugation. For example, the disengaging means 504 may only be used after the dispensing element 402 has filled the pot.

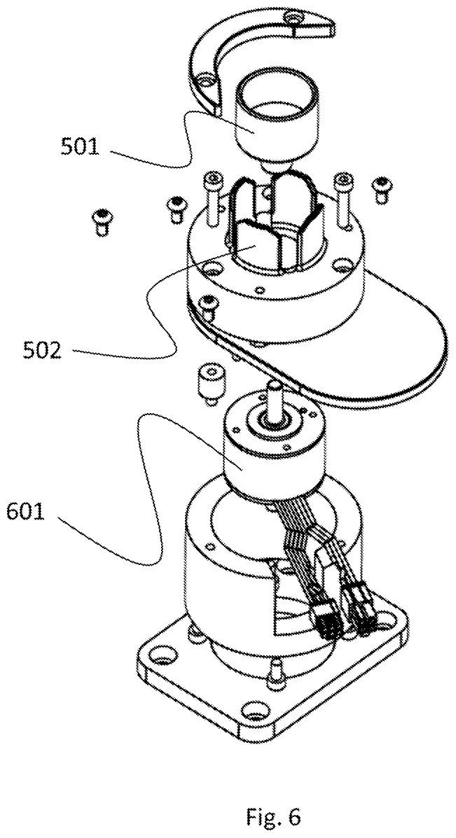

Additional components of a centrifuge instrument that can be used to spin the pot are shown in FIG. 6.

The rotor 501 may be driven by a brushless DC motor 601. The holding means 502 may be part of the instrument housing, and may align the cartridge with the rotor 501 and ensure spacing between the cartridge and the spinning rotor, such that the cartridge cannot become misaligned during centrifugation or provide friction against the rotor 501.

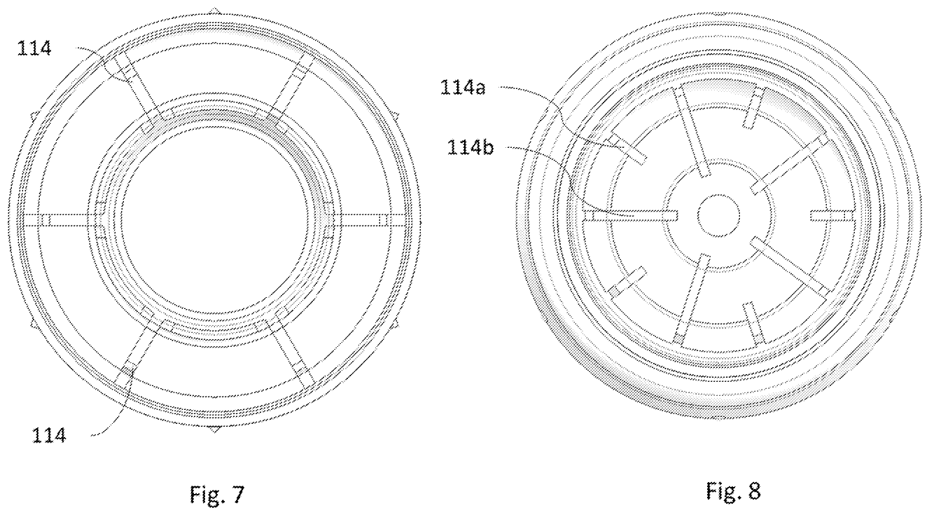

In the above description and referenced figures, the pot has been shown to have scalloped baffles 114. As mentioned above, these baffles may be omitted and the invention may instead rely on the protrusion 202. Additionally, the baffles can take a variety of forms and can vary in their number. For example, in one example, the baffles can protrude straight from the wall 111 toward the centre 201 and be of equal length and height, as shown in FIG. 7. In this example, there are six baffles.

The number of radial baffles 114 can also be adapted depending on the properties of the liquid being centrifuged within the pot. In general, a pot with more radial baffles will help maintain separation better. For example, the pot of FIG. 8 has 10 baffles. However, as the number of baffles increases, this will reduce the available volume of the pot as well as provide more points for liquid to become trapped, or ‘pinned’, due to surface tension.

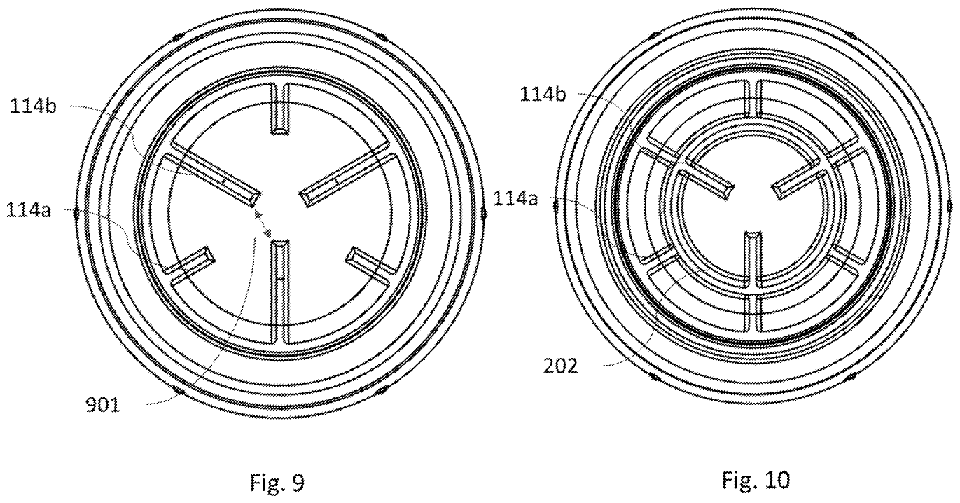

To help overcome this issue, additionally, the baffles 114 may comprise a first baffle 114a that protrudes from the wall 111 by a first distance and a second baffle 114b that protrudes from the wall by a second distance, the first distance being different from the second distance. The baffles 114 may comprise plural of each type of baffle 114a, 114b, as shown in FIG. 8 and FIG. 9. This arrangement enables more of the baffles to protrude further in toward the centre of the pot which helps to prevent remixing of the blood and plasma under deceleration without making the opening from the pot into the baffled zones too small, which might otherwise cause issues with surface tension pinning in pots with small dimensions. The smaller length baffles act to provide more “separated” compartments whilst maintaining an minimum width of opening 901 between the baffles large that is enough to prevent pinning via surface tension.

In many examples, this means that the baffles do not protrude as far as the centre 201, and protrude from the wall 111 by a distance less than a radius of the pot.

Additionally, more complex baffle arrangements can be used such as shown in FIG. 10. In this example, baffles 114a, 114b of different lengths are connected to the protrusion 202. With this example, the “compartments” defined by the baffles may be truly separated from the rest of the inner volume (in a plane perpendicular to the central axis 112) for at least part of the height of the pot, making remixing of cellular matter 301 and plasma 302 yet slower or even impossible.

The shape of the baffles can also affect how the device performs. In a preferred embodiment described above, the shape of the baffles can be formed as an angled scallop which further helps to keep the blood and plasma separated, as shown in FIG. 1.

As mentioned above, upon deceleration, the inertia of the blood against the slowing pot, causes much of the cellular matter to become trapped in the corners 304 of the baffles reducing the chance of remixing. This effect is present even with straight baffles, but is amplified with scalloped baffles.

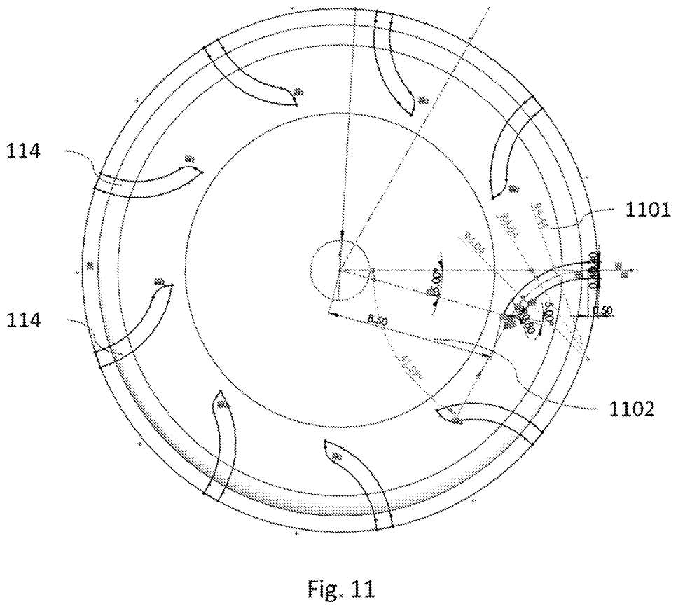

Further detail of a particularly advantageous scalloped baffle embodiment is shown in FIG. 11.

In particular, as shown in FIG. 11 the scalloped baffles are formed as an arc of a curve of a radius 1101 between 0.25 and 0.35 of the radius of the pot, in a plane defined by the central axis 112 (as opposed to curving in a vertical plane). Alternatively, where the pot is polygonal as described above, the scalloped baffles may be formed as an arc of a curve having a radius between 0.12 and 0.18 of a width of the pot.

Additionally, as shown in FIG. 11, the scalloped baffles protrude into the inner volume by a distance of between 0.25 and 0.5 of the radius of the pot, as illustrated in FIG. 11 by the distance 1102 between the centre 201 and the and end of a baffle 114. Alternatively, where the pot is polygonal as described above, the scalloped baffles may protrude into the inner volume by a distance of between 0.25 and 0.5 of the average half-width of the pot.

Other shapes of baffle are also possible. For example, a top or bottom end of a baffle may be horizontal, or may curve in a vertical plane parallel to the central axis 112 towards or away from the bottom end 113 of the pot, as the baffle 114 protrudes away from the wall 111.

Specific examples of baffles have been described by reference to FIGS. 7 to 11. More generally, various combinations of baffle number, baffle length(s), baffle shape and connectivity between baffles and the protrusion 202 are envisaged.

The above-described examples have been applied specifically to centrifugation of blood into plasma and cellular matter. However, the invention is equally applicable for centrifugation of other biological fluids comprising multiple components, such as urine. Different biological fluids require different centrifuge speeds, but the baffle 114 and protrusion 202 features are applicable to any mixture of components of different densities.

1. A pot for centrifugal separation of a biological fluid into multiple components, the pot comprising a wall around a central axis, a top end and a bottom end, wherein the pot comprises:
a plurality of baffles protruding from the wall into an inner volume of the pot;
and/or a protrusion from the bottom end into the inner volume and around the central axis.

2. A pot according to claim 1, wherein the pot is adapted to be spun on the central axis for centrifugal separation of the biological fluid in the inner volume, wherein the multiple components remain separated once the pot ceases to spin.

3. A pot according to claim 1, wherein each of the plurality of baffles does not protrude as far as a centre of the pot, and extends along the wall for between half of and all of a distance between the top end and the bottom end.

4. A pot according to claim 1, wherein the plurality of baffles are substantially equally spaced around the central axis.

5. A pot according to claim 1, wherein the plurality of baffles comprises a first baffle that protrudes from the wall by a first distance and a second baffle that protrudes from the wall by a second distance, the first distance being different from the second distance.

6. A pot according to claim 1, wherein the plurality of baffles are each formed as an arc of a curve in a plane defined by the central axis, the curve having a radius between 0.12 and 0.18 of a width of the pot.

7. A pot according to claim 1, wherein the protrusion from the bottom end is formed around the central axis with a width of approximately half of a width of the pot, and protrudes between 1 mm and 4 mm from the bottom end.

8. A pot according to claim 1, wherein the centrifugal separation separates plasma towards the central axis, and the pot is adapted to enable a component of the biological fluid to be extracted through an opening in the top end.

9. A pot according to claim 1, wherein a width of the pot is less than 40 mm.

10. A pot according to claim 1, wherein a distance between the top end and the bottom end is less than 30 mm.

11. A pot according to claim 1, wherein the pot is adapted to be spun at at least 10,000 RPM.

12. A pot according to claim 1, wherein the biological fluid is blood and the multiple components of the biological fluid comprise plasma and cellular matter.

13. A consumable cartridge comprising:
a pot according to claim 1,
a cartridge body adapted to receive the pot, and
a first holding means for holding the pot at least partly within the cartridge body,
wherein the first holding means is adapted to allow the pot to rotate.

14. A consumable cartridge according to claim 13, further comprising a second holding means adapted to securely hold the pot in place until the cartridge is inserted into a centrifuge instrument, and to release the pot to spin freely when the cartridge is inserted into the centrifuge instrument.

15. A consumable cartridge according to claim 13, further comprising a dispensing element adapted to dispense a biological fluid into the pot, and an aspirating element adapted to extract a component of the biological fluid from the pot, wherein the cartridge does not comprise any moving parts other than the pot.

16. A consumable cartridge according to claim 13, adapted to hold the pot at least partly within the cartridge body when the pot is spinning at at least 10,000 RPM.
